(19) United States
(12) Patent Application Publication
(10) Pub. No.: US 2011/0111712 A1
(43) Pub. Date: May 12, 2011

(54) BROADCASTING RECEIVER

(76) Inventor: Masayuki MIYAMOTO, Osaka (JP)

(21) Appl. No.: 12/905,722

(22) Filed: Oct. 15, 2010

(30) Foreign Application Priority Data
Nov. 10, 2009 (JP) 2009-256657

(51) Int. Cl. H04B 1/18

(52) U.S. Cl. 455/150.1

(57) ABSTRACT

Provided is a broadcasting receiver (A), which includes: a tuner unit (2) for receiving and demodulating a broadcast signal of a given broadcast system; a signal processing circuit (3) for processing a signal output from the tuner unit (2); and a circuit board (1) which has the tuner unit (2) and the signal processing circuit (3) mounted on a surface thereof. The broadcasting receiver (A) further includes connection units (25, 10) for connecting the tuner unit (2) and the circuit board (3) to each other so that the signal output from the tuner unit (2) is properly input to the signal processing circuit (3).

This application is based on Japanese Patent Application No. 2009-256657 filed on Nov. 10, 2009, the contents of which are hereby incorporated by reference.

### BACKGROUND OF THE INVENTION

1. Field of the Invention

The present invention relates to a broadcasting receiver capable of supporting broadcast signals of various broadcast systems through replacement of a tuner unit according to the broadcast system.

2. Description of Related Art

In recent years, in the field of TV broadcasting, various countries have started implementing terrestrial digital broadcasting, and the conventional analog broadcasting is being gradually converted into the digital broadcasting. During the conversion, the analog broadcasting and the digital broadcasting are simultaneously transmitted, and hence broadcasting receivers capable of receiving one of the analog broadcasting and the digital broadcasting are increasing in number (see, for example, Japanese Patent Application Laid-open No. 2008-99151).

Further, broadcasting receivers capable of receiving both the analog broadcasting and the digital broadcasting are also increasing in number. Such a broadcasting receiver is provided with a circuit board, a tuner circuit, a digital demodulating circuit, and a signal processing circuit. The tuner circuit, which is mounted on the circuit board, receives a broadcast signal, generates an intermediate frequency (IF) signal, and demodulates the IF signal to generate an analog video signal (csync video black/white signal: CVBS) and an analog audio (sound intermediate frequency: SIF) signal (the CVBS and the SIF signal both being intermediate-frequency signals). The digital demodulating circuit demodulates the IF signals output from the tuner circuit, to thereby generate a transport stream (TS) signal. The signal processing circuit processes the CVBS/SIF signal transmitted from the tuner circuit and (or) the TS signal transmitted from the digital demodulating circuit, and outputs an internal signal for an apparatus incorporating the broadcasting receiver. The apparatus incorporating the broadcasting receiver is, for example, a TV receiver or a DVD recorder.

At present, the terrestrial analog broadcasting and the terrestrial digital broadcasting are provided in different broadcast systems, depending on the country or the region. When the broadcast system is different, the broadcast signal thereof and the demodulation system or the like therefore are also different. Conventionally, a broadcasting receiver provided with circuits (such as a tuner circuit, a digital demodulating circuit, and a signal processing circuit) capable of supporting the broadcast system of the intended country is manufactured and shipped to the country.

However, in the case of the conventional broadcasting receiver, there has been a problem as follows. That is, all the circuits including the circuit board are designed and manufactured individually depending on the intended country, which is inefficient in terms of design and manufacture.

Meanwhile, there is a broadcasting receiver provided with tuner circuits and digital demodulating circuits for supporting a plurality of broadcast systems (see, for example, Japanese Patent Application Laid-open No. 2003-230060). However, when receiving a broadcast signal of a certain broadcast system, the rest of the tuner circuits and the digital demodulating circuits for supporting the other broadcast systems are not used, which is wasteful. Further, the number of components such as a tuner circuit and a digital demodulating circuit to be mounted on the circuit board increases, which complicates the wiring to be formed on the circuit board and increases the size of the circuit board.

### SUMMARY OF THE INVENTION

The present invention has been made in view of the above-mentioned problems, and therefore, it is an object of the present invention to provide a broadcasting receiver which is simple and compact in configuration and capable of receiving a broadcast signal of one of a plurality of different broadcast systems.

According to one aspect of the present invention, there is provided a broadcasting receiver, including: a tuner unit for receiving and demodulating a broadcast signal of a given broadcast system of a plurality of different broadcast systems, the tuner unit being one of a plurality of different tuner units; a signal processing circuit for processing a signal output from the tuner unit; and a circuit board which has the tuner unit and the signal processing circuit mounted thereon. The broadcasting receiver further includes connection means for connecting the tuner unit to the circuit board so that the signal output from the tuner unit is properly input to the signal processing circuit, and supports the plurality of different broadcast systems through replacement of the tuner unit mounted on the circuit board.

With this configuration, the tuner unit and the circuit board are connected to each other so that the signal output from the tuner unit is properly input to the signal processing circuit, irrespective of the broadcast system to be supported. Accordingly, there may be manufactured a broadcasting receiver capable of supporting various broadcast systems merely through replacement of the tuner unit, without replacing the circuit board and the signal processing circuit.

In this manner, the circuit board and the signal processing circuit may be shared in common among a plurality of broadcast systems, which therefore improves efficiency in design and manufacture. Further, there is no need to hold in stock different circuit boards and different signal processing circuits according to the intended countries, which also improves efficiency in manufacture.

In a preferred embodiment according to the present invention, the connection means includes a plurality of first connection terminals provided to the tuner unit, and a plurality of second connection terminals formed in the circuit board, and the plurality of first connection terminals and the plurality of second connection terminals are arranged so that the plurality of first connection terminals are each connected to a corresponding one of the plurality of second connection terminals.

In a preferred embodiment according to the present invention, the plurality of first connection terminals are the same in number as the plurality of second connection terminals.

In a preferred embodiment according to the present invention, the plurality of first connection terminals are smaller in number than the plurality of second connection terminals.

With this configuration, the second connection terminals are formed according to a maximum number of connection terminals to be required by a broadcast system, and hence more various tuner units may be mounted on the circuit board, to thereby support a larger number of broadcast systems.

In a preferred embodiment according to the present invention, the plurality of first connection terminals and the plurality of second connection terminals are arranged in a first line and in a second line, respectively, and, when the tuner unit that has the plurality of first connection terminals smaller in number than the plurality of second connection terminals is connected to the circuit board, the tuner unit is connected so that at least one of the second connection terminals arranged at both ends of the second line is left unconnected.

In a preferred embodiment according to the present invention, the connection means includes at least two different lines in which the plurality of second connection terminals are arranged, and the plurality of first connection terminals are connected to the plurality of second connection terminals arranged in one of the at least two different lines, according to the broadcast system to be supported by the tuner unit.

In a preferred embodiment according to the present invention, the plurality of first connection terminals are arranged two-dimensionally, and the plurality of second connection terminals are arranged two-dimensionally so that the plurality of first connection terminals are connected thereto.

In a preferred embodiment according to the present invention, the tuner unit includes an external input connector for receiving a signal externally input thereto, and, when the tuner unit and the circuit board are connected to each other, the external input connector is constantly disposed at the same position with respect to the circuit board, irrespective of the tuner unit to be connected.

### BRIEF DESCRIPTION OF THE DRAWINGS

FIG. 1 is a schematic perspective view of an example of a broadcasting receiver according to the present invention;

FIG. 2 is a block diagram of the broadcasting receiver illustrated in FIG. 1;

FIG. 3 is a diagram illustrating connection between tuner units and a TV board in an example of the broadcasting receiver according the present invention;

FIG. 4 is a diagram illustrating how connection terminals and terminal holes are associated with one another in another example of the broadcasting receiver according to the present invention;

FIG. 5 is a diagram illustrating how the connection terminals and the terminal holes are associated with one another in a further example of the broadcasting receiver according to the present invention;

FIG. 6 is a diagram illustrating how the connection terminals and the terminal holes are associated with one another in a still further example of the broadcasting receiver according to the present invention;

FIG. 7 is a diagram illustrating how the connection terminals and the terminal holes are associated with one another in a yet further example of the broadcasting receiver according to the present invention; and

FIG. 8 is a diagram illustrating how the connection terminals and the terminal holes are associated with one another in a yet further example of the broadcasting receiver according to the present invention.

### DETAILED DESCRIPTION OF PREFERRED EMBODIMENTS

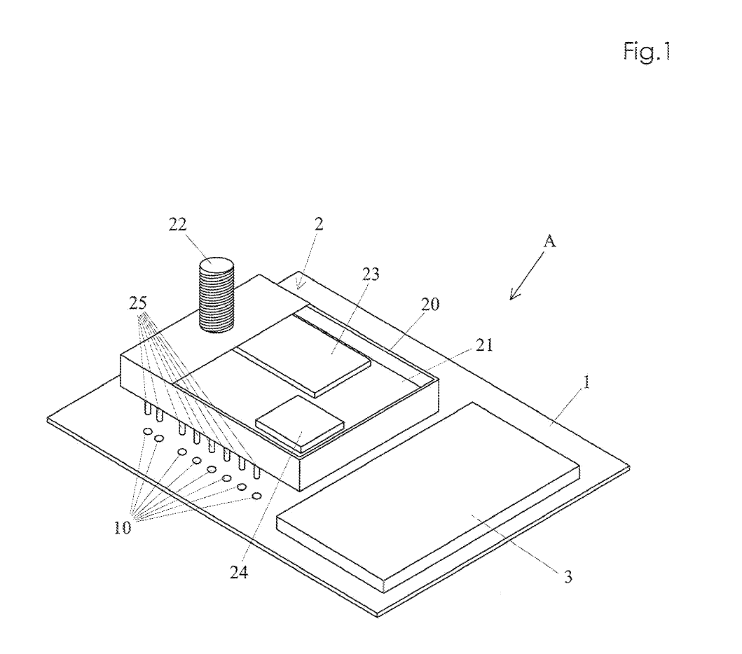

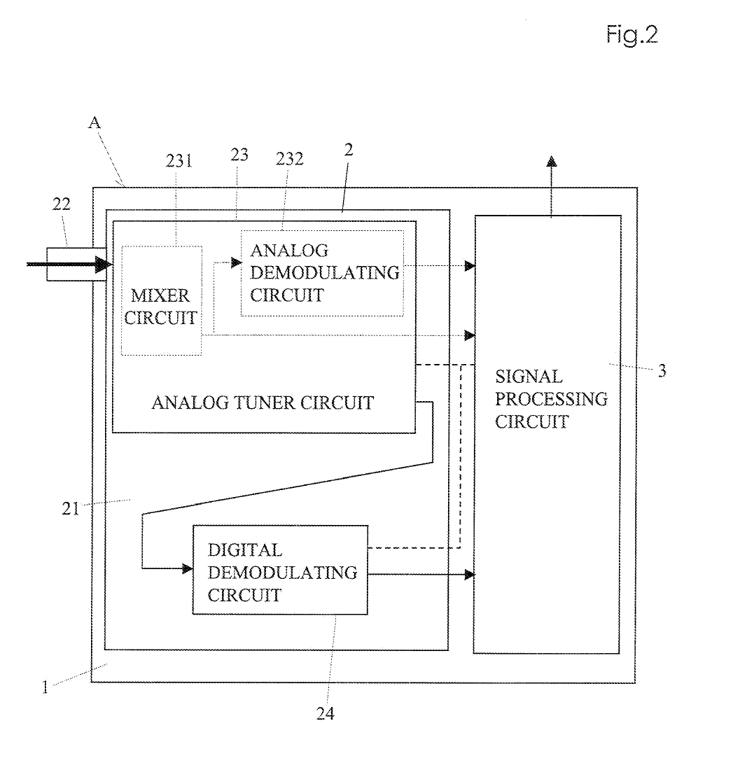

In the following, embodiments of the present invention are described with reference to the accompanying drawings. FIG. 1 is a schematic perspective view of an example of a broadcasting receiver according to the present invention, and FIG. 2 is a block diagram of the broadcasting receiver illustrated in FIG. 1. Here, the broadcasting receiver illustrated in FIGS. 1 and 2 is a TV broadcasting receiver capable of receiving terrestrial analog broadcasting and terrestrial digital broadcasting. It should be noted that the broadcasting receiver according to the present invention receives broadcast signals of different broadcast systems. In the following description, two broadcast systems are taken as an example for the sake of simplicity. However, the broadcast systems should not be limited to those two types. Further, the “different broadcast systems” relate to analog broadcast systems or digital broadcast systems which are different from each other depending on the country or the region. The same applies below unless specifically defined otherwise.

FIGS. 1 and 2 each illustrate a broadcasting receiver A which includes a TV board 1 serving as a main circuit board, a tuner unit 2 mounted on the TV board 1, and a signal processing circuit 3 for processing a signal transmitted from the tuner unit 2, the signal processing circuit 3 being mounted on the TV board 1. As illustrated in FIG. 1, the TV board 1 has eight terminal holes 10 (second connection terminals) formed therein, which are arranged in a line.

As illustrated in FIG. 1, the tuner unit 2 includes a tuner board 21 and a shield case 20 surrounding the tuner board 21. The shield case 20 is provided with an external input connector 22 for connection to an antenna wire (not shown). The external input connector 22 is connected to an antenna (not shown) for receiving terrestrial TV broadcasting, and is in common use between analog broadcasting and digital broadcasting. The tuner unit 2 of this example includes only a single external input connector 22. However, the present invention is not limited thereto. The tuner unit 2 may further include, in addition to the external input connector 22 for receiving an input of a terrestrial broadcast signal as described above, an external input connector for receiving an input of a broadcast signal of satellite broadcasting such as broadcast satellite (BS) broadcasting or communications satellite (CS) broadcasting, or an external input connector for receiving an input of a broadcast signal of cable broadcasting.

Further, the tuner board 21 has an analog tuner circuit 23 and a digital demodulating circuit 24 mounted thereon. As illustrated FIG. 2, the analog tuner circuit 23 includes a mixer circuit 231 for converting a radio-frequency (RF) signal of high-frequency into an intermediate-frequency (IF) signal, and an analog demodulating circuit 232 for demodulating the IF signal into a csync video black/white signal (CVBS) (analog video signal) and a sound intermediate frequency (SIF) signal (analog audio signal). In a case where the received broadcast signal is a broadcast signal for digital broadcasting, the analog tuner circuit 23 transmits, to the digital demodulating circuit 24, the IF signal converted from the RF signal. The IF signal is demodulated into a transport stream (TS) signal by the digital demodulating circuit 24. In this example, the mixer circuit 231 and the analog demodulating circuit 232 are contained in the analog tuner circuit 23 of a single chip. However, the mixer circuit 231 and the analog demodulating circuit 232 each may be separately formed of individual chips or circuits.

As illustrated in FIG. 1, the tuner board 21 includes eight connection terminals 25 (first connection terminals). The connection terminals 25 are inserted into the eight terminal holes 10 formed in the TV board 1, to thereby mount the tuner unit 2 on the TV board 1. It should be noted that the connection terminals 25 are arranged in line with the arrangement of the terminal holes 10 so as to fit into the terminal holes 10. The arrangement is described later in detail.

The connection terminals 25 and the terminal holes 10 constitute connection means for connecting between the TV board 1 and the tuner unit 2. The terminal holes 10 penetrates printed wiring formed on the TV board 1, and the connection terminals 25 and the printed wiring are electrically connected to each other by means of a generally-known connecting method such as soldering.

The connection terminals 25 of the tuner unit 2 are configured to allow different signals to flow therethrough. The connection terminals 25 are each assigned with, for example, an output and (or) an input of signals such as a power supply signal, a ground signal, a CVBS, an SIF signal, an IF signal, a TS signal, and a control signal.

The control signal is used for transmitting tuning information (frequency) on each channel to the analog tuner circuit 23, and for transmitting, to the digital demodulating circuit 24, error correction information on the TS signal. In other words, the control signal is used for monitoring a status of the tuner unit 2, and for transmitting a condition for reception. In the following description, the control signal is exchanged via a bus called I2C bus. However, the present invention is not limited thereto.

The connection terminals 25 of the tuner unit 2 are each inserted into an appropriate one of the terminal holes 10, to thereby connect the connection terminals 25 to the printed wiring. As a result, each signal output from the tuner unit 2 may be transmitted to each circuit for processing signals, in the signal processing circuit 3. For example, a connection terminal for outputting a TS signal is connected to a Moving Picture Experts Group (MPEG) 2 decoder circuit in the signal processing circuit 3, via the printed wiring.

The signal processing circuit 3 is described in detail. The signal processing circuit 3 includes processing circuits for processing video and audio signals, such as a transport stream processor, an MPEG2 decoder, an audio processor, and a panel processor, which are integrated into one processing circuit. The signal processing circuit 3 may include in advance a plurality of processing circuits capable of supporting a plurality of broadcast systems, or may be configured to include a programmable logic circuit. In a case of using the programmable logic circuit, processing circuits respectively designed for each broadcast system may be stored in a memory, and each of the processing circuits may be read out according to the broadcast system. Alternatively, a processing circuit capable of processing the broadcast signal of the broadcast system supported by the tuner unit 2 may be stored in a storage part such as a memory, when the tuner unit 2 is mounted.

Next, a description is given of a case of mounting tuner units supporting different broadcast systems on a common TV board, with reference to the accompanying drawings. In the following description, a broadcasting receiver for receiving two different broadcast systems is described for the sake of simplicity.

### First Embodiment

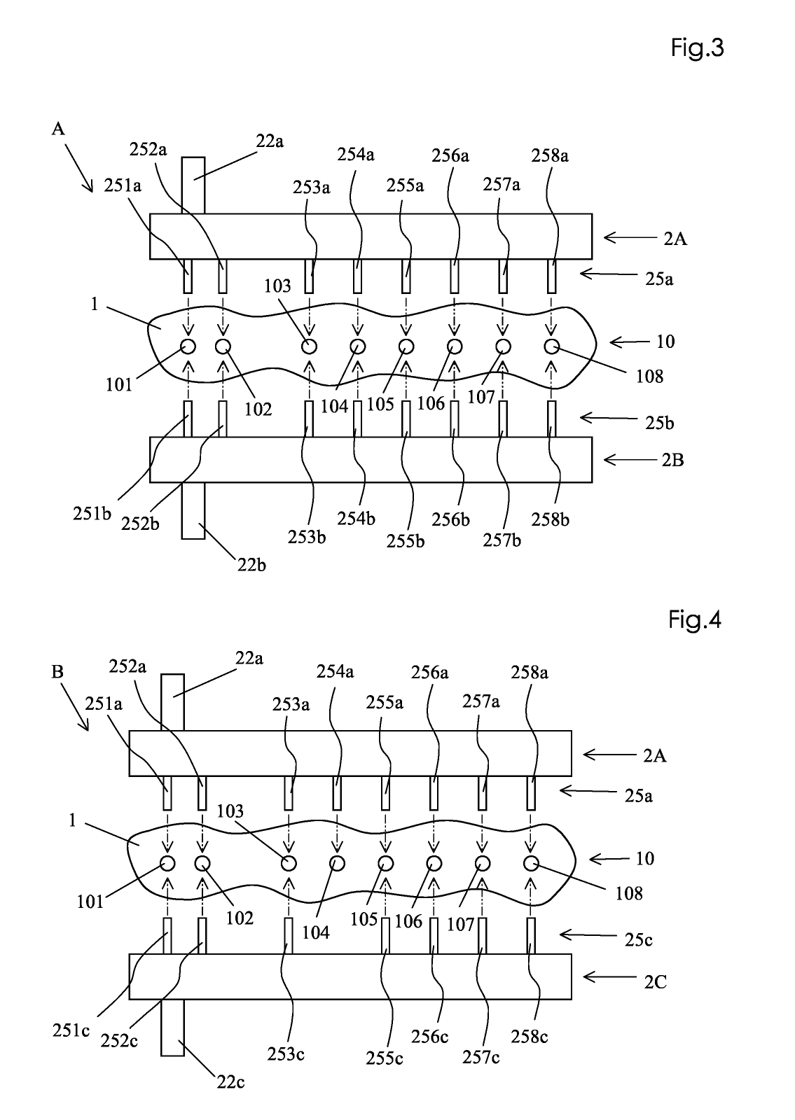

FIG. 3 is a diagram illustrating connection between the tuner units and the TV board in an example of the broadcasting receiver according to the present invention. In the broadcasting receiver A of FIG. 3, the tuner units and the terminal holes of the TV board are schematically illustrated. The broadcasting receiver A is configured to be capable of allowing any one of a first tuner unit 2A for receiving a broadcast signal of a first broadcast system and a second tuner unit 2B for receiving a broadcast signal of a second broadcast system to be selectively mounted thereon.

As illustrated in FIG. 3, eight terminal holes 10 (second connection terminals) are formed in the TV board 1, which are arranged in a line. Across the terminal holes 10, the first tuner unit 2A for receiving broadcasting of the first broadcast system is disposed on an upper side of the drawing, while the second tuner unit 2B for receiving broadcasting of the second broadcast system is disposed on a lower side of the drawing. It should be noted that, in FIG. 3, for the sake of description, the first tuner unit 2A has connection terminals 25a (first connection terminals) provided downward while the second tuner unit 2B has connection terminals 25b (first connection terminals) provided upward, which merely illustrates correspondence between the connection terminals and the terminal holes and is different from an actual mounting state. In practice, both the first tuner unit 2A and the second tuner unit 2B are mounted from the same surface side of the TV board 1 with the plurality of the connection terminals 25a or 25b being inserted into the plurality of the terminal holes 10 (see FIG. 1).

First, a description is given of a case where the broadcasting receiver A receives the first broadcast system. As illustrated in FIG. 3, the terminal holes 10 of the TV board 1 include a power supply terminal hole 101, a ground terminal hole 102, I2C bus terminal holes 103 and 104, an analog video signal (CVBS) terminal hole 105, a sound intermediate frequency (SIF) signal terminal hole 106, an intermediate frequency (IF) signal terminal hole 107, and a transport stream (TS) signal terminal hole 108, which are arranged in the stated order from the left.

Meanwhile, the first tuner unit 2A for receiving the first broadcast system is provided with the connection terminals which are the same in number with the terminal holes 10 (101 to 108). That is, the first tuner unit 2A is provided with eight connection terminals 25a (251a to 258a). The connection terminals 25a include a power source terminal 251a, a ground terminal 252a, I2C bus connection terminals 253a and 254a, a CVBS terminal 255a, an SIF signal terminal 256a, an IF signal terminal 257a, and a TS signal terminal 258a.

In the TV board 1, the power supply terminal hole 101 and the ground terminal hole 102 are formed at a distance from the rest of the terminal holes 10. With this configuration, only when the tuner unit 2A is mounted on the TV board 1 with the power supply terminal 251a being inserted into the power supply terminal hole 101 while the ground terminal 252a being inserted into the ground terminal hole 102, the rest of the connection terminals are correctly inserted into the corresponding terminal holes. In this manner, there may be prevented a case where the tuner unit 2A is incorrectly positioned on the TV board 1, for example, a case where a connection terminal other than the power supply terminal 251a is inserted into the power supply terminal hole 101, or a case where the tuner unit 2A is mounted in the wrong direction.

The connection terminals 251a to 258a of the connection terminals 25a are each inserted into the corresponding one of the terminal holes 101 to 108 of the terminal holes 10, to thereby connect the first tuner unit 2A to the TV board 1. In this manner, the connection terminals 251a to 258a are each inserted into corresponding one of the terminal holes 101 to 108 as described above, and hence each signal (mainly, a data signal) from the first tuner unit 2A is properly transmitted to the corresponding processing circuit in the signal processing circuit 3. Further, signals (mainly, control signals) from the signal processing circuit 3 are each properly transmitted to a target portion of the first tuner unit 2A. The connection terminals 25a are installed into the terminal holes 10 of the TV board 1, to thereby allow the broadcasting receiver A to receive a broadcast signal of the first broadcast system.

Meanwhile, the second tuner unit 2B also includes eight connection terminals 25b (251b to 258b). The connection terminals 25b (251b to 258b) are inserted into the terminal holes 10 (101 to 108), to thereby mount the second tuner unit 2B on the TV board 1. It should be noted that the connection terminals 25B of the second tuner unit 2B are arranged in line with the arrangement of the terminal holes 10, which is the same in arrangement as the first tuner unit 2A. Similarly to the first tuner unit 2A, the second tuner unit 2B may also be mounted without an error, and the broadcasting receiver A is allowed to receive a broadcast signal of the second broadcast system.

As described above, the connection terminals are unified in terms of number, position, and signals to be associated therewith, to thereby allow any one of the first tuner unit 2A and the second tuner unit 2B to be mounted on the TV board 1 which is used in common In other words, the TV board 1 may be shared in common irrespective of the broadcast system. Further, as described above, the signal processing circuit 3 is also employed in common, and hence the broadcasting receiver A is capable of receiving broadcast signals of different broadcast systems by having the tuner unit 2 selected according to the broadcast system and mounted thereon.

### Second Embodiment

FIG. 4 is a diagram illustrating how connection terminals and terminal holes are associated with one another in another example of the broadcasting receiver according to the present invention. FIG. 4 illustrates a broadcasting receiver B, in which the tuner units and the terminal holes of the TV board are schematically illustrated. The broadcasting receiver B illustrated in FIG. 4 is configured to be capable of allowing any one of the first tuner unit 2A for supporting a broadcast signal of the first broadcast system and a third tuner unit 2C for supporting a broadcast signal of a third broadcast system to be selectively mounted thereon.

The first tuner unit 2A is the same in configuration as that of the broadcasting receiver an illustrated in FIG. 3, and hence a detailed description thereof is omitted herein. The first tuner unit 2A is mounted on the TV board 1, which enables the broadcasting receiver B to receive a broadcast signal of the first broadcast system.

Next, a description is given of a case of mounting the third tuner unit 2C for receiving a broadcast signal of the third broadcast system on the TV board 1. As illustrated in FIG. 4, in the third tuner unit 2C, connection terminals 25c (first connection terminals) include only one I2C bus connection terminal (connection terminal 253c). The number of the connection terminals 25c is seven, which is smaller by one as compared to that of the first tuner unit 2A. The third tuner unit 2C may be disposed so that a power supply terminal 251c and a ground terminal 252c are each placed on the power supply terminal hole 101 and on the ground terminal hole 102, respectively, to thereby allow the rest of the connection terminals to be placed on the corresponding connection terminal holes. As a result, the connection terminals are connected to the corresponding terminal holes through the insertion of the connection terminals into the terminal holes.

As described above, signals exchanged between the connection terminals and the terminal holes to be used are made sharable irrespective of the number of connection terminals of the tuner unit, and hence the TV board may be shared in common among the tuner units that are different in terms of the number of the connection terminals.

It should be noted that the second embodiment exemplifies a case where the number of the connection terminals of the first tuner unit 2A is equal to the number of the terminal holes 10 of the TV board 1. However, the number of the connection terminals of the first tuner unit 2A may be smaller than the number of the terminal holes 10 of the TV board 1. Alternatively, for example, in a case of a broadcasting receiver for a country (region) where the service of the terrestrial analog broadcasting is ended, there is no need to provide the tuner unit with connection terminals for outputting analog video and audio signals, and hence those terminals may be omitted. The tuner unit with no connection terminal for analog output may still be mounted on the TV board 1 as long as the rest of the connection terminals (power supply, ground, I2C, IF, and TS) are properly matched with the terminal holes. Even in a case of a broadcasting receiver for a country (region) where the digital broadcasting has not started, the TV board 1 may be shared as long as the connection terminals for analog output are properly matched with the terminal holes.

### Third Embodiment

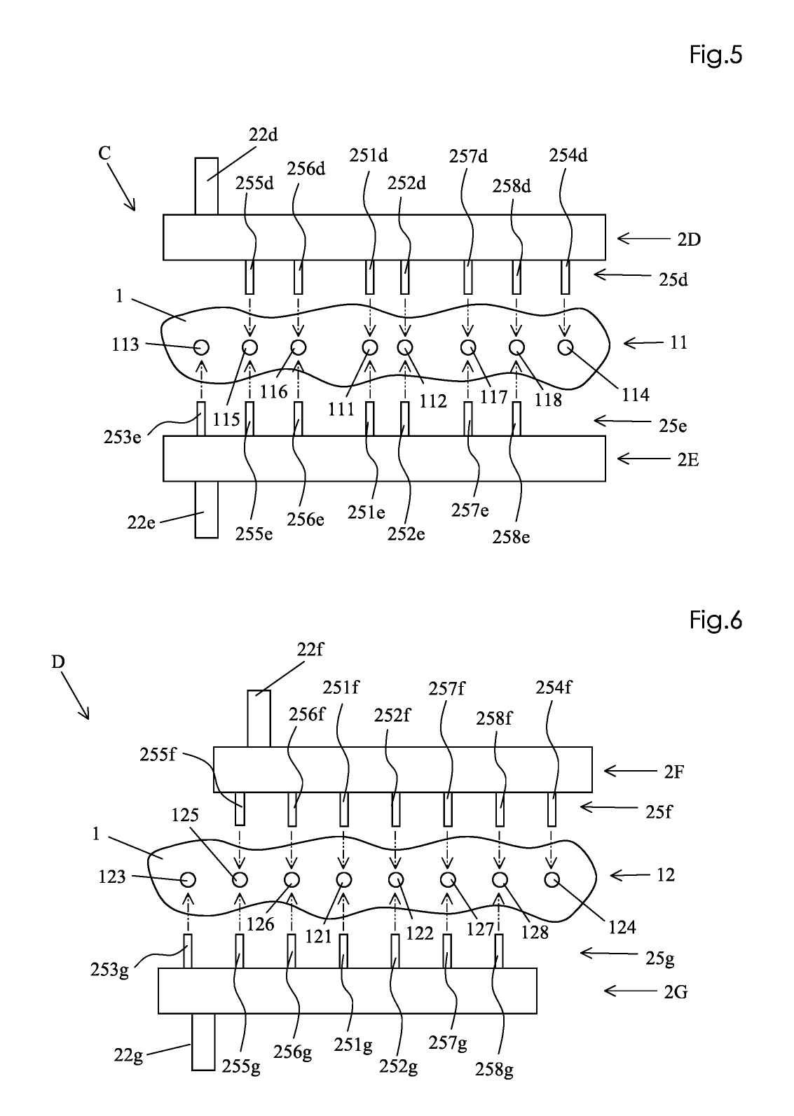

A description is given of a further example of how to mount a tuner unit on the TV board of the broadcasting receiver according to the present invention, with reference to the drawing. FIG. 5 is a diagram illustrating how the connection terminals and the terminal holes are associated with one another in the further example of the broadcasting receiver according to the present invention. FIG. 5 illustrates a broadcasting receiver C, in which tuner units and the terminal holes of the TV board are schematically illustrated. The broadcasting receiver C illustrated in FIG. 5 is configured to be capable of allowing any one of a fourth tuner unit 2D for supporting a broadcast signal of a fourth broadcast system and a fifth tuner unit 2E for supporting a broadcast signal of a fifth broadcast system to be selectively mounted thereon.

As illustrated in FIG. 5, eight terminal holes 11 (second connection terminals) are formed in the TV board 1 of the broadcasting receiver C. The terminal holes 11 include a power supply terminal hole 111, a ground terminal hole 112, an analog signal (of video and audio) terminal holes 115 and 116, an intermediate frequency signal terminal hole 117, a digital signal terminal hole 118, and I2C bus terminal holes 113 and 114, which are arranged in a line. The power supply terminal hole 111 and the ground terminal hole 112 are arranged in the center. The analog signal terminal holes 115 and 116 are arranged on the left of the drawing while the intermediate frequency terminal hole 117 and the digital signal terminal hole 118 are arranged on the right. The I2C bus terminal holes 113 and 114 are arranged at both ends of the line.

Connection terminals 25d (first connection terminals), which are arranged in a line, of the fourth tuner unit 2D include, on the right end of the arrangement in the drawing, an I2C bus terminal 254d to be matched with the I2C bus terminal hole 114. The number of the connection terminals 25d is seven in total. As illustrated in FIG. 5, the fourth tuner unit 2D is mounted on the TV board 1 such that the I2C bus terminal 254d arranged on the right end of the arrangement in the drawing is inserted into the I2C bus terminal hole 114. As a result, the rest of the connection terminals are inserted into the corresponding terminal holes. The fourth tuner unit 2D does not include a connection terminal to be inserted into the terminal hole 113 on the left end of the arrangement in the drawing, and hence the terminal hole 113 remains free. It should be noted that, as illustrated in FIG. 5, the connection terminals and the terminal holes are not necessarily arranged at regular intervals, and hence the rest of the connection terminals are inserted into the terminal holes only when the rightmost connection terminal 254d is placed on the rightmost terminal hole 114.

On the other hand, connection terminals 25e (first connection terminals), which are arranged in a line, of the fifth tuner unit 2E include, on the left end of the arrangement in the drawing, an I2C bus terminal 253e to be matched with the I2C bus terminal hole 113. The number of the connection terminals 25e is seven in total. As illustrated in FIG. 5, the fifth tuner unit 2E is mounted on the TV board 1 such that the I2C bus terminal 253e arranged on the left end of the arrangement in the drawing is inserted into the I2C bus terminal hole 113. There is provided no connection terminal to be inserted into the terminal hole 114 on the right end of the arrangement in the drawing, and hence the terminal hole 114 remains free. It should be noted that, as illustrated in FIG. 5, the connection terminals and the terminal holes are not necessarily arranged at regular intervals, and hence the rest of the connection terminals are inserted into the terminal holes only when the leftmost connection terminal 253e is placed on the leftmost terminal hole 113.

The I2C bus terminal hole 113 remains free when the fourth tuner unit 2D is mounted, while the I2C bus terminal hole 114 remains free when the fifth tuner unit 2E is mounted. In other words, the fourth tuner unit 2D and the fifth tuner unit 2E each require one I2C bus. At this time, the signal processing circuit 3 may include a circuit for determining that the fourth tuner unit 2D is mounted when no signal is received from the terminal hole 113, and that the fifth tuner unit 2E is mounted in a reverse case, that is, when no signal is received from the terminal hole 114.

As described above, signals exchanged between the connection terminals and the terminal holes to be used are made sharable irrespective of the number of connection terminals of the tuner unit, and hence the TV board may be shared in common among the tuner units that are different in terms of the number of the connection terminals. With this configuration, the degree of freedom in arrangement positions of the connection terminals increases, which therefore increases the degree of freedom in design of the tuner unit.

In the above-mentioned embodiments, when the connection terminals are inserted into the terminal holes, because the distances between the adjacent connection terminals or between the adjacent terminal holes are not always constant, the connection terminals and the terminal holes are always associated with one another one by one in mounting the tuner unit on the TV board. With the connection terminals and the terminal holes being arranged as described above, the external input connector 22 may be disposed in a constant position with respect to the TV board 1 even when the tuner unit is replaced. With this configuration, apparatuses (such as, for example, a TV receiver and an optical disc device) incorporating the broadcasting receiver each may have a casing sharing the same shape, irrespective of the broadcast system.

In the above-mentioned embodiments, some of the distances between the adjacent terminal holes are configured to be different from one another. However, the present invention is not limited thereto. All of the adjacent terminal holes may be configured to be arranged at the same intervals, or at different intervals.

### Fourth Embodiment

A description is given of a still further example of how to mount a tuner unit on the TV board of the broadcasting receiver according to the present invention, with reference to the drawing. FIG. 6 is a diagram illustrating how the connection terminals and the terminal holes are associated with one another in the still further example of the broadcasting receiver according to the present invention. FIG. 6 illustrates a broadcasting receiver D, in which tuner units and the terminal holes of the TV board are schematically illustrated. The broadcasting receiver D illustrated in FIG. 6 is configured to be capable of allowing any one of a sixth tuner unit 2F for supporting a broadcast signal of a sixth broadcast system and a seventh tuner unit 2G for supporting a broadcast signal of a seventh broadcast system to be selectively mounted thereon.

As illustrated in FIG. 6, eight terminal holes 12 (second connection terminals) of the TV board 1 are arranged in a line such that all the distances between the adjacent terminal holes 12 are the same. Connection terminals 25f (first connection terminals) of the sixth tuner unit 2F are arranged such that a connection terminal 254f on the right end of the arrangement in the drawing is inserted into a terminal hole 124 on the right end of the arrangement line in the drawing of the TV board 1. On the other hand, connection terminals 25g (first connection terminals) of the seventh tuner unit 2G are arranged such that a connection terminal 253g on the left end of the arrangement in the drawing is inserted into a terminal hole 123 on the left end of the arrangement line in the drawing of the TV board 1.

Further, the sixth tuner unit 2F and the seventh tuner unit 2G are configured to be different from each other in terms of the I2C bus terminals, while the number of and the arrangement positions of the connection terminals other than the I2C bus terminals are the same. When the connection terminals 25f of the sixth tuner unit 2F are properly inserted into the terminal holes 12, an external input connector 22f is displaced to the right in the drawing. On the other hand, when the connection terminals 25g of the seventh tuner unit 2G are properly inserted into the terminal holes 12, an external input connector 22g is displaced to the left in the drawing.

As described above, the external input connectors 22f and 22g are mounted as being displaced from each other, a manufacturer and (or) a user can visually identify whether the broadcasting receiver D in which a tuner unit is mounted on the TV board is intended for receiving a broadest signal of the sixth broadcast system or a broadcast signal of the seventh broadcast system. As a result, there may be prevented a failure of mistakenly mounting a wrong broadcasting receiver for a broadcast system on an apparatus that is to incorporate the broadcasting receiver. It should be noted that the fourth embodiment exemplifies a case where the number of the connection terminals is smaller by one than the number of the terminal holes. However, the difference in number is not limited to one, and the number of the connection terminals may be smaller by two or more than the number of the terminal holes. Alternatively, the connection terminals of one of the tuner units may be the same in number as the terminal holes.

### Fifth Embodiment

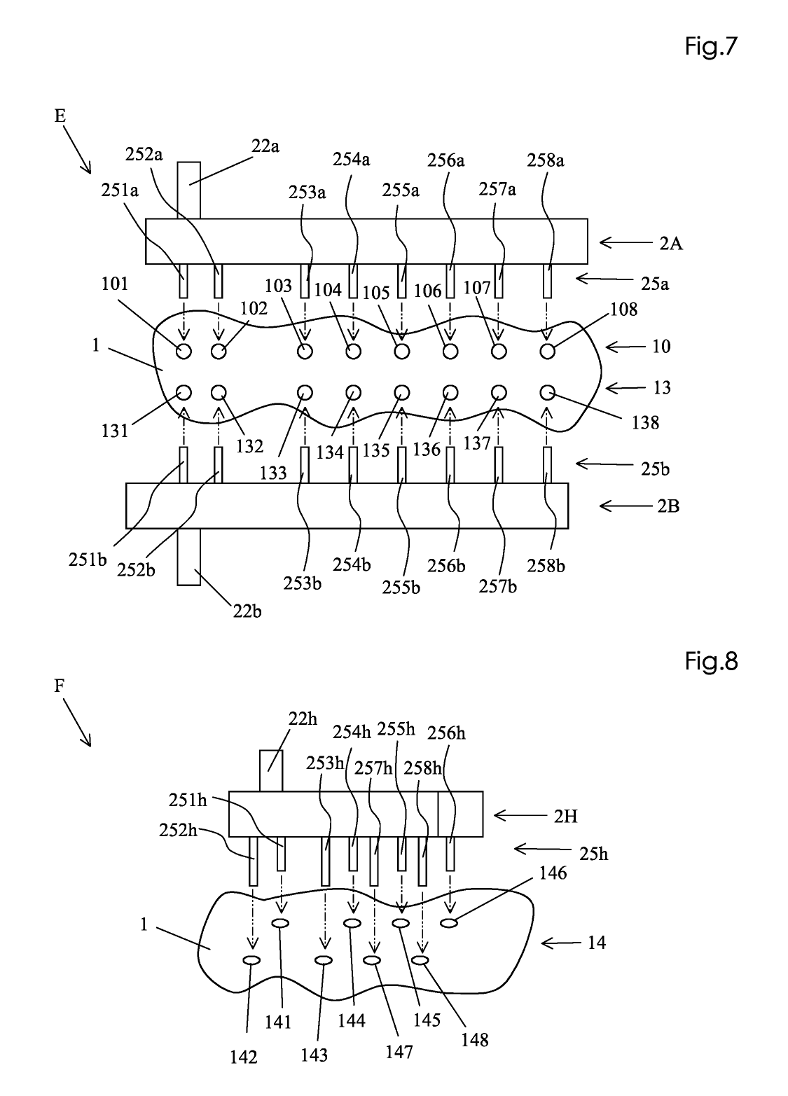

A description is given of a further example of how to mount a tuner unit on the TV board of the broadcasting receiver according to the present invention, with reference to the drawing. FIG. 7 is a diagram illustrating how the connection terminals and the terminal holes are associated with one another in the further example of the broadcasting receiver according to the present invention. FIG. 7 illustrates a broadcasting receiver E, in which tuner units and the terminal holes of the TV board are schematically illustrated. The broadcasting receiver E illustrated in FIG. 7 is configured to be capable of allowing any one of the first tuner unit 2A for supporting a broadcast signal of the first broadcast system and the second tuner unit 2B for supporting a broadcast signal of the second broadcast system to be selectively mounted thereon.

The broadcasting receiver E has eight terminal holes 10 (second connection terminals) and eight terminal holes 13 (second connection terminals) formed therein. The connection terminals 25a (first connection terminals) of the first tuner unit 2A are to be inserted into the eight terminal holes 10 (second connection terminals). The connection terminals 25b (first connection terminals) of the second tuner unit 2B are to be inserted into the eight terminal holes 13 (second connection terminals). The eight terminal holes 10 and the eight terminal holes 13 are arranged in lines, respectively, in directions parallel to each other. In other words, the TV board 1 includes terminal holes arranged in two different lines.

In the broadcasting receiver E, the TV board 1 is formed such that the connection holes for receiving the connection terminals of the first tuner unit 2A when mounting the first tuner unit 2A are different in line from the connection holes for receiving the connection terminals of the second tuner unit 2B when mounting the second tuner unit 2B. With this configuration, the arrangement order of the connection terminals may be made different between the first tuner unit 2A and the second tuner unit 2B, which therefore increases the degree of freedom in design of the tuner unit itself. As a result, wiring of a circuit board inside the tuner unit may be optimized, and hence the tuner unit may easily be reduced in size.

It should be noted that, in the fifth embodiment, the description is given of a tuner unit in which the number of the connection terminals is the same as the number of the terminal holes. However, there may be employed a tuner unit in which the number of the connection terminals is smaller than the number of terminal holes. Further, the description is given by taking as an example a case where the terminal holes in two lines, namely, the terminal holes 10 and terminal holes 13, are provided. However, the present invention is not limited thereto, and the terminal holes may be provided in three or more lines. Further, the terminal holes 10 and 13 in the fifth embodiment are respectively arranged in lines independent of each other. However, the terminal holes may be arranged in such a manner that some of the terminal holes are shared (for example, the arrangement lines may intersect with each other).

### Sixth Embodiment

A description is given of a yet further example of how to mount a tuner unit on the TV board of the broadcasting receiver according to the present invention, with reference to the drawing. FIG. 8 is a diagram illustrating how the connection terminals and the terminal holes are associated with one another in the yet further example of the broadcasting receiver according to the present invention. FIG. 8 illustrates a broadcasting receiver F, in which a tuner unit and the terminal holes of the TV board are schematically illustrated. The broadcasting receiver F illustrated in FIG. 8 is configured to be capable of allowing an eighth tuner unit 2H to be mounted thereon.

As illustrated in FIG. 8, the TV board 1 includes eight (4×2) terminal holes 14 (second connection terminals), which are two-dimensionally arranged. The eighth tuner unit 2H includes eight connection terminals 25h (first connection terminals), which are arranged in such positions that allow the connection terminals to be inserted into the terminal holes 14.

The connection terminals 25h and the terminal holes 14 are arranged two-dimensionally, and hence the length of an area in the arrangement direction of the connection terminals be reduced. Further, the connection terminals are easy to insert into the terminal holes, as compared to the connection terminals arranged one-dimensionally. Still further, owing to the two-dimensional arrangement of the connection terminals, a load to be applied in a direction orthogonal to the arrangement direction of the connection terminals is reduced, as compared to the case where the connection terminals arranged one-dimensionally. As a result, breakage of the tuner unit is suppressed.

In the above-mentioned embodiments, the description has been given of an exemplary case where the connection terminals serving as connection means are inserted into the terminal holes directly formed in the TV board, and are electrically connected to the wiring formed through soldering or the like on a surface of the TV board. However, the present invention is not limited thereto, and the connection terminals of the tuner unit may be connected through soldering or the like to a connection land (wiring pattern on the circuit board) with no terminal holes, which is formed on the TV board. Alternatively, the connection terminals of the tuner unit may be configured to be connected to the TV board through a holding member such as a socket which is capable of detachably holding the connection terminals by a spring force or the like. The number of and the assignment of signals to the connection terminals (terminal holes) are not limited to those of the above-mentioned embodiments.

In each of the above-mentioned embodiments, the description has been given of an exemplary case where a tuner unit for supporting any one of two different broadcast systems is connected to the TV board in common use. However, the present invention is not limited thereto, and three or more types of tuner units for supporting a broadcast system may be connected to a common TV board. In this case, any of the methods of the above-mentioned embodiments may be employed, or a plurality of the methods may be used in combination.

The above-mentioned embodiments have been given by way of describing the present invention, and it is to be understood that the embodiments are not intended to limit the invention described in the scope of the following claims or to restrict the scope of claims. It will be understood that each configuration of the present invention is not limited to the above-mentioned embodiments, and various modifications may be made thereto without departing from the technical idea described in the scope of claims.

The present invention may be applied to a broadcasting receiver for receiving analog broadcasting and digital broadcasting, which is disposed, for example, inside a TV receiver or a disk device (blu-ray disc (BD) or DVD).

What is claimed is:

1. A broadcasting receiver, comprising:
a tuner unit for receiving and demodulating a broadcast signal of a given broadcast system of a plurality of different broadcast systems, the tuner unit being one of a plurality of different tuner units;
a signal processing circuit for processing a signal output from the tuner unit;
a circuit board which has the tuner unit and the signal processing circuit mounted thereon; and
connection means for connecting the tuner unit to the circuit board so that the signal output from the tuner unit is properly input to the signal processing circuit,
wherein the broadcasting receiver supports the plurality of different broadcast systems through replacement of the tuner unit mounted on the circuit board.

2. A broadcasting receiver according to claim 1,
wherein the connection means comprises:
a plurality of first connection terminals provided to the tuner unit; and
a plurality of second connection terminals formed in the circuit board, and
wherein the plurality of first connection terminals and the plurality of second connection terminals are arranged so that the plurality of first connection terminals are each connected to a corresponding one of the plurality of second connection terminals.

3. A broadcasting receiver according to claim 2, wherein the plurality of second connection terminals are connected to the plurality of first connection terminals which are the same in number as the plurality of second connection terminals.

4. A broadcasting receiver according to claim 2, wherein the plurality of second connection terminals are connected to the plurality of first connection terminals which are smaller in number than the plurality of second connection terminals.

5. A broadcasting receiver according to claim 4,
wherein the plurality of first connection terminals and the plurality of second connection terminals are arranged in a first line and in a second line, respectively, and
wherein, when the tuner unit that has the plurality of first connection terminals smaller in number than the plurality of second connection terminals is connected to the circuit board, the tuner unit is connected so that at least one of the second connection terminals arranged at both ends of the second line is left unconnected.

6. A broadcasting receiver according to claim 2,
wherein the connection means includes at least two different lines in which the plurality of second connection terminals are arranged, and
wherein the plurality of first connection terminals are connected to the plurality of second connection terminals arranged in one of the at least two different lines, according to the broadcast system to be supported by the tuner unit.

7. A broadcasting receiver according to claim 2,
wherein the plurality of first connection terminals are arranged two-dimensionally, and
wherein the plurality of second connection terminals are arranged two-dimensionally so that the plurality of first connection terminals are connected thereto.

8. A broadcasting receiver according to claim 1,
wherein the tuner unit includes an external input connector for receiving a signal externally input thereto, and
wherein, when the tuner unit and the circuit board are connected to each other, the external input connector is constantly disposed at the same position with respect to the circuit board, irrespective of the tuner unit to be connected.
